(19) United States
(12) Patent Application Publication
(10) Pub. No.: US 2024/0295795 A1
(43) Pub. Date: Sep. 5, 2024

(54) SPLIT SCREEN FEATURE FOR MACRO PHOTOGRAPHY

(71) Applicant: Corephotonics Ltd., Tel Aviv (IL)

(72) Inventor: Gal Shabtay, Tel Aviv (IL)

(21) Appl. No.: 18/661,744

(22) Filed: May 13, 2024

Related U.S. Application Data
(63) Continuation of application No. 17/762,948, filed on Mar. 23, 2022, now Pat. No. 12,007,668.
(60) Provisional application No. 63/080,047, filed on Sep. 18, 2020.
(60) Provisional application No. 63/032,576, filed on May 30, 2020.
(60) Provisional application No. 62/980,184, filed on Feb. 22, 2020.

(51) Int. Cl. G03B 13/02; G03B 37/04; G06V 10/147; H04N 23/45; H04N 23/63; H04N 23/67

(52) U.S. Cl. CPC G03B 13/02; G03B 37/04; G06V 10/147; H04N 23/45; H04N 23/635; H04N 23/67

(57) ABSTRACT

Mobile electronic devices comprising a first camera with a first field of view FOV₁, a second, Macro camera with a Macro field of view FOV_{M} smaller than FOV₁, and a device screen that includes a first screen section configured to display first image data from the first camera and a second screen section configured to display second image data from the Macro camera when both cameras are focused to a distance equal to or smaller than 30 cm.

### CROSS REFERENCE TO RELATED APPLICATIONS

This is a continuation application from U.S. patent application Ser. No. 17/762,948 filed Mar. 23, 2022 (now allowed), which was a 371 application from international patent application PCT/IB2021/050639 filed Jan. 27, 2021, and is related to and claims the benefit of priority from U.S. Provisional patent applications No. 62/980,184 filed 22 Feb. 2020, U.S. Pat. No. 63,032,576 filed 30 May 2020, and U.S. Pat. No. 63,080,047 filed 18 Sep. 2020, all of which are incorporated herein by reference in their entirety.

### FIELD

The subject matter disclosed herein relates in general to Macro images and in particular to methods for obtaining such images with multi-cameras (e.g. dual-cameras).

### BACKGROUND

Multi-aperture digital cameras (or multi-cameras) are standard for mobile electronic devices (e.g. smartphones, tablets, etc.). A multi-camera usually comprises a camera with a wide field-of-view (or “angle”) FOV_{W} (“Wide” camera), and at least one additional camera, either with the same FOV (e.g. a depth auxiliary camera), with a narrower (than FOV_{W}) field of view FOV_{T} (Telephoto or “Tele” camera), or with an ultra-wide field of view FOV_{UW} wider than FOV_{W} (“UW camera”). In some embodiments below, a Wide or Ultra-Wide camera may be referred to as a “non-Macro camera”.

A “Macro-photography” mode is becoming a popular differentiator for smartphone cameras. “Macro-photography” refers to photographing objects that are very close to the camera, so that the image size of an object recorded on the image sensor is nearly as large as the actual size of the object photographed, i.e. it has a large object: image magnification (M) of e.g. 10:1 to 1:1. Such an image may be referred to as “Macro image”. First smartphones that include a Macro camera with a Macro FOV (FOV_{M}), often based on an UW camera have entered the consumer market. A Macro camera can be realized with a Tele camera. An advantage is the high magnification M of a Macro images captures with a Tele camera, so that one may speak of a “Super Macro Image”. In some examples, the Macro camera may be a scanning Tele camera which can scan a scene with its native FOV_{M}, for example as described in co-owned U.S. Pat. No. 10,578,948.

Macro images are recorded at very small object-camera distances of around 20 cm or less. A UW camera may still be capable to focus to these small distances. Generally, very small objects (e.g., less than 1 cm in size) are targeted as image objects (i.e. are objects of interest or “OOIs”). Such very small OOIs for a Macro image may be occluded by the multi-camera hosting device, making it difficult to point the Macro camera to capture the OOI in a precise manner. This is especially significant when FOV_{M} captures a small area (e.g. a few square millimeters) of an object (e.g., placed 2 cm to 10 cm away from the camera) while being integrated in a large device. It would be beneficial to have a method that supports a quick and user-friendly way to direct a Macro camera FOV_{M} towards very small OOIs.

### SUMMARY

In some embodiments there is provided a split screen view on a multi-camera hosting device showing a preview image segment of an ultra-wide camera FOV together with a preview image segment of the FOV_{M} to support the targeting of an OOI with the FOV_{M}.

The image segment of an ultra-wide camera FOV being displayed to the user may contain some differentiating element marking the area of the OOI that is to be captured by the Macro mode. Such differentiating element marking may include a touchable box, for example a rectangular box. The user may get a feedback on the screen in which direction the multi-camera hosting device is to be moved to catch the OOI with the FOV_{M}.

In various embodiments there are provided mobile electronic devices, comprising a first camera with a first field of view FOV₁, a second, Macro camera with a Macro field of view FOV_{M} smaller than FOV₁ and a device screen that includes a first screen section configured to display first image data from the first camera and a second screen section configured to display second image data from the Macro camera when both cameras are focused to a distance equal to or smaller than 30 cm.

In some embodiments, the FOV_{M} is shown and marked within the first screen section.

In some embodiments, the first screen section includes a visual indication for guiding a user of the mobile electronic device towards a scene using the FOV_{M}.

In some embodiments, the second screen section displays first image data from the first camera.

In some embodiments, a device further comprises a controller for controlling a change in state of the Macro camera based on the first image data. In some embodiments, the state of the Macro camera is a zoom state. In some embodiments, the state of the Macro camera is a focus state.

In some embodiments, the first camera has a focal length between 2 and 7 mm.

In some embodiments, the Macro camera has a focal length between 12 and 40 mm.

In some embodiments, the Macro camera has a focal length between 14 and 30 mm.

In some embodiments, the Macro camera has a focal length between 15 and 20 mm.

In some embodiments, both cameras can be focused to a distance smaller than 20 cm.

In some embodiments, both cameras can be focused to a distance of 10 cm or less.

In some embodiments, at least one camera can be focused to a distance between 5 and 10 cm.

In some embodiments, at least one camera can be focused to a distance of 5 cm or less.

In some embodiments, at least one camera can be focused to a distance of 3 cm or less.

In some embodiments, the first camera is an Ultra-Wide camera.

In some embodiments, the first camera is a Wide camera.

In some embodiments, the Macro camera is a scanning Tele camera. In some embodiments, the device further comprises a controller for controlling a change of a scan state of the Macro camera based on the first image data.

In some embodiments, the Macro camera is a Tele camera having different zoom states.

In some embodiments, the first camera is focused to a first distance different from a second distance that the Macro camera is focused to.

In some embodiments, the first screen section and the second screen section are split vertically when the mobile electronic device is held in a landscape orientation, and the first screen section and the second screen section are split horizontally when the mobile electronic device is held in a portrait orientation.

In some embodiments, the device is a smartphone.

In some embodiments, the device further comprises a controller for controlling a change of a scan state of the Macro camera based on the first image data.

In various embodiments there are provided methods, comprising providing a mobile electronic device that includes a first camera with a first field of view FOV₁, a second, Macro camera with a Macro field of view FOV_{M} smaller than FOV₁, and a device screen, focusing the first camera and the Macro camera to a distance≤30 cm, and displaying on a first section of the device screen first image data from the first camera and displaying on a second section of the device screen second image data from the second camera.

In some embodiments, the focusing of the first camera and of the Macro camera to a distance≤30 cm includes focusing the first camera to a first distance≤30 cm and focusing the Macro camera to a distance≤30 cm different from the first distance.

In some embodiments, the focusing of the first camera and of the Macro camera to a distance≤30 cm includes focusing both cameras to a distance of 20 cm or less.

In some embodiments, the focusing of the first camera and of the Macro camera to a distance≤30 cm includes focusing both cameras to a distance of 10 cm or less.

In some embodiments, the focusing of the first camera and of the Macro camera to a distance≤30 cm includes focusing both cameras or one of the cameras to a distance of 5 cm or less.

In some embodiments, the focusing of the first camera and of the Macro camera to a distance≤30 cm includes focusing both cameras or one of the cameras to a distance of 3 cm or less.

In some embodiments, a method further comprises showing and marking the FOV_{M} within the first screen section.

In some embodiments, a method further comprises including in the first screen section a visual indication for guiding a user of the mobile electronic device towards a scene using the FOV_{M}.

In some embodiments, a method further comprises displaying the first image data in the second screen section.

In some embodiments, a method further comprises controlling a change in state of the Macro camera based on the first image data.

In some embodiments, the controlling a change in state of the Macro camera includes controlling a change of a state selected from the group consisting of a scan state, a zoom state and a focus state of the Macro camera.

In some embodiments, the Macro camera is a scanning Tele camera and the controlling a change in state of the Macro camera based on the first image data includes automatically controlling a change of a scan state of the scanning Tele camera.

In some embodiments, the Macro camera is a Tele camera having different zoom states and the controlling a change in state of the Macro camera includes automatically controlling a change of a zoom state of the Tele camera.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein, and should not be considered limiting in any way. Like elements in different drawings may be indicated by like numerals. Elements in the drawings are not necessarily drawn to scale.

FIG. 1 shows schematically dual-camera output image sizes and ratios between an ultra-wide FOV and a Macro FOV;

FIG. 2A illustrates a smartphone having an ultra-wide camera, a Macro camera, and a screen split into two sections, one exhibiting FOV_{UW} (or a cropped area of it) and one exhibiting FOV_{M} (or a cropped area of it), according to an embodiment disclosed herein;

FIG. 2B illustrates a first stage in a process of moving the smartphone and the FOV_{M} in the camera of FIG. 2A towards an OOI, as seen in each section of the screen;

FIG. 2C illustrates a final stage in the process of moving the smartphone and the FOV_{M} in the camera of FIG. 2A towards an OOI, as seen in each section of the screen;

FIG. 3 shows a split screen view according to another embodiment disclosed herein;

FIG. 4 shows in a flow chart of a method of use of a split screen for Macro-photography in a mobile electronic device, according to embodiments disclosed herein;

FIG. 5 shows schematically an embodiment of an electronic device including a multi-camera and configured to perform methods disclosed herein.

### DETAILED DESCRIPTION

Embodiments disclosed herein solve the problem of occlusion of an object of interest when Macro-photography is performed with multi-cameras included in smartphones and other mobile electronic devices. For simplicity and for example only, the solution is illustrated with a dual-camera, with the understanding that it is also clearly applicable with multi-cameras having three or more cameras.

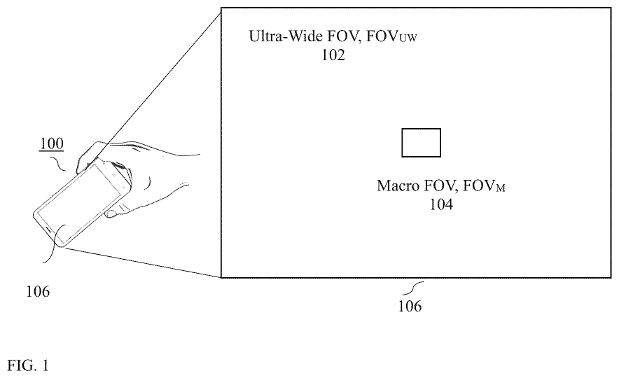

FIG. 1 illustrates a typical field of-view (FOV) ratio of smartphone 100 including a multi-camera (not shown) that includes a UW camera with a FOV_{UW} 102 covering a large segment of a scene and a Macro camera with a FOV_{M} 104 covering a small segment of a scene. One can see exemplary sizes and ratios between UW and Macro output images.

In some examples, the Macro camera may be a continuous Tele zoom camera where FOV_{M} changes with changing ZF.

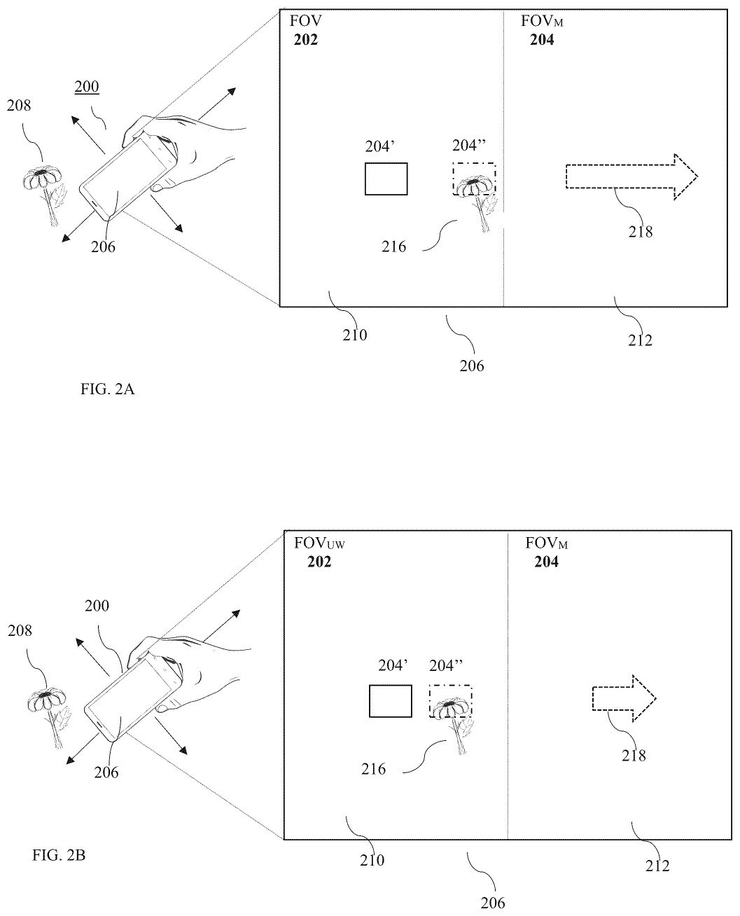

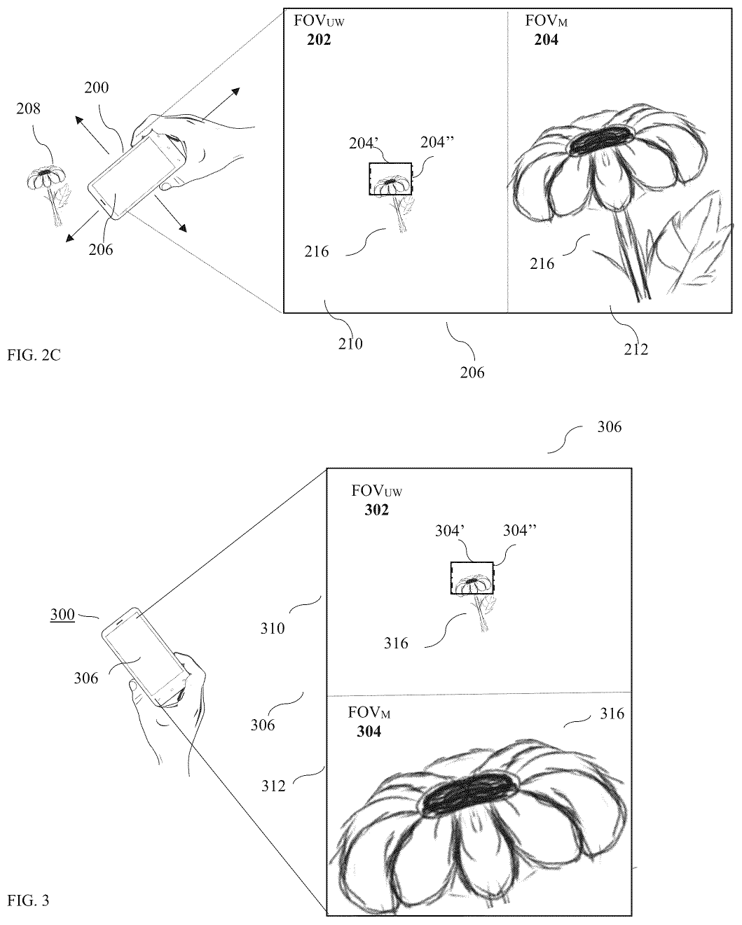

FIG. 2A illustrates an embodiment numbered 200 of a smartphone having a UW camera with a FOV_{UW} 202 and a Macro camera with a FOV_{M} 204 and a screen (display) 206 according to presently disclosed subject matter. A system description of smartphone 200 is given in FIG. 5. As indicated by four arrows in FIG. 2A-C, smartphone 200 may be moved by a user in four or more directions for manually moving FOV towards an OOI/ROI. Screen 206 illustrates a first screen example for displaying images of a multi-camera. Macro photography is required to capture small objects from a close range. The Macro camera may include a Tele lens with a focal length much larger (e.g., 3 times to 25 times) than the focal length of the UW camera. In such a case, the UW camera can easily focus to a close range (e.g. 2 cm to 30 cm), but its spatial resolution is poor since its focal length is small and its FOV is large. For example, consider a UW camera with 2.5 mm focal length and a Macro camera with 25 mm focal length. The two cameras may include identical or different sensors (e.g., with identical or different pixel count and pixel size). Assume that both cameras include the same sensor, e.g., with 4 mm active image sensor width. When focused to 5 cm, the Macro camera will have a M of 1:1 and will capture an object width of 4 mm (same as the sensor width). The UW camera will have a M of 19:1 and will capture an object width of 76 mm.

In some examples, for performing a method disclosed herein, a smartphone like smartphone 200 may comprise, instead of or additionally to the UW camera with FOV_{UW} 202, a W camera with a FOV_{W} (not shown) that is smaller than FOV_{UW} 202 but still larger than FOV_{M}. In some examples, the W camera may not be able to focus to an object as close as e.g. 10 cm. In such examples, for performing a method disclosed herein, the W camera may be focused to its minimal focus distance, e.g. to 20 cm.

The UW or W cameras mentioned above have a larger depth of field than a Macro capable Tele camera with FOV_{M}. A ROI is easier to detect in UW or W image data than in Macro image data. Therefore, one may use UW or W or M camera image data for automatic ROI detection and selection.

In an exemplary case, a user wishes to use smartphone 200 for capturing an OOI (e.g. a flower 208 which forms an image 216 in a camera) or a ROI with very high (Macro) resolution. For methods of use as disclosed herein, screen 206 is split into two sections, a first section 210 (possibly cropped) and a second section 212. The first screen section may display first image data from the first camera with FOV₁ and the second screen section may display second image data from the second camera with FOV_{M}. The examples here show a “split screen” view on the screen, i.e. the two screen sections are shown side by side. In other examples (not shown) one may display a “picture-in-picture” view on the screen, i.e. one screen section may be shown as an inlay in the other screen section. In some examples, the second screen section may be shown on the entire screen or on a large segment of the screen except on a segment where the first screen section is shown, and wherein the first screen section covers a smaller area on the screen than the second screen. In the embodiment of FIGS. 2A-2C, the two screen sections have exemplarily a “landscape” orientation, i.e. first screen section and the second screen section are split vertically, beneficial when the device is held in landscape orientation. Screen 206 may include additional icons or symbols as known (not shown). First screen section 210 displays a cropped FOV_{UW} (and can be therefore called “UW screen section 210”) while second screen section 212 displays the Macro FOV_{M} (and can be therefore called “Macro screen section 212”). Inside first section 210, FOV_{M} 204 can be marked by a physical (i.e. visible on the screen) rectangle 204′. Rectangle 204′ indicates the actual position of FOV_{M} 204 with respect to FOV_{UW} 202. Optionally, another physical rectangle 204″ indicates a UW preview of OOI (flower) 208 in order to guide a user towards flower 208. The user can see the position of FOV_{M} 204 relative to rectangle 204″ at all times in UW screen section 210, while at the same time, Macro screen section 212 exhibits the scene within FOV_{M}. In use, the user moves the smartphone with camera towards flower 208. In Macro screen section 212, an arrow 218 indicates the direction and distance of movement required to align flower 208 with Macro FOV_{M} 204. In some examples, image data from UW FOV 202 may be displayed in Macro screen section 212. This is for example beneficial when the Macro camera may not be in focus over entire camera FOV_{M} 204 or when there are other optical or image quality issues.

FIG. 2B, 2C show the process of moving the smartphone (and the FOV_{M}) towards flower 208 (i.e. toward preview 216). In FIG. 2B, the UW screen section indicates that the movement of FOV_{M} 204 brings it close to rectangle 204″ (preview 216). The flower starts to appear in Macro screen section 212. In FIG. 2C, FOV_{M} 204 is seen in the UW screen section as fully overlapping rectangle 204″, while flower 208 is displayed fully in Macro screen section 212.

FIG. 3 illustrates an embodiment numbered 300 of a smartphone having a UW camera with a FOV_{UW} 302 and a Macro camera with a FOV_{M} 304 and a screen 306 according to presently disclosed subject matter. Screen 306 is split into a UW screen section 310 and a Macro screen section 312, both in portrait orientation, i.e. first screen section and second screen section are split horizontally, beneficial when device is held in portrait orientation. As in FIG. 2C, inside first section 310, FOV_{M} 304 is marked by a physical rectangle 304′, and, optionally, another physical rectangle 304″ indicates a UW preview of a flower 308 (which forms an image 316 in a camera) in order to guide the user towards flower 308.

Such a method or apparatus in which the screen is split and both the ultra-wide FOV and Macro FOV are shown allows the user to find an OOI and capture it with the Macro camera (and possibly also simultaneously with the UW camera) even if the handset (image capture device) occludes the OOI.

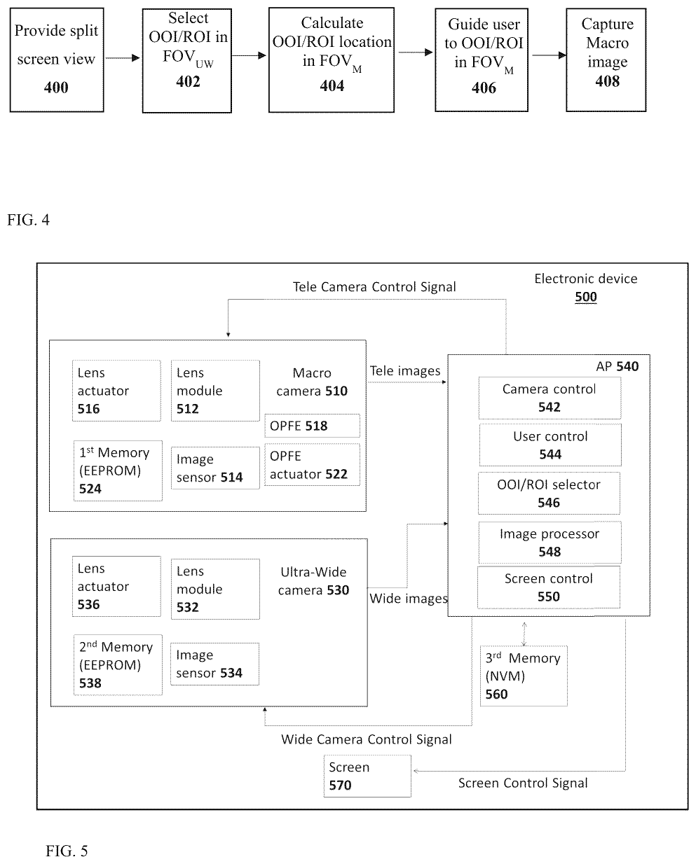

FIG. 4 shows in a flow chart of a method of use of a split screen for Macro-photography in a mobile electronic device, according to embodiments disclosed herein. In step 400, a screen of a mobile electronic device is split to display both a non-Macro (e.g. UW) camera image stream (or cropped version of it) and a Macro camera image stream (or cropped version of it) simultaneously. In step 402, an OOI/ROI as a scene for the Macro image is selected in the FOV_{UW} of the UW camera by a dedicated algorithm running on OOI/ROI selector 546 or by a human user. FOV_{UW} and FOV_{M} are calibrated. As known in the art, the position of the OOI/ROI in FOV_{UW} can be translated to a respective OOI/ROI position in FOV_{M}. In step 404, the respective position of the OOI/ROI with respect to FOV_{M} is calculated based on the OOI/ROI location position in FOV_{UW}. In step 406, the user is visually or otherwise guided towards the OOI/ROI's location position with respect to the FOV_{M}. The visual or otherwise indication for the guiding may be visual (e.g. by arrow 218 shown in FIGS. 2A-B) or via a dedicated sound or via some haptic feedback. In some examples, user control unit 544 is configured to provide visual or otherwise indication. According to the guiding of step 406, the user moves the camera's hosting device (e.g. smartphone) until the OOI/ROI appears in FOV_{M}. In step 408, the user captures a Macro image (also referred to as “Super Macro image”) of the OOI/ROI.

FIG. 5 shows schematically an embodiment of an electronic device (e.g. a smartphone) numbered 500 that includes a multi-camera and is configured to perform methods disclosed herein. Electronic device 500 comprises a Macro camera 510 with FOV_{M}. Macro camera 510 includes a Macro lens module 512 with a Macro lens, a Macro image sensor 514 and a lens actuator 516 for actuating Macro lens module 512. The Macro lens forms a Macro image recorded by Macro image sensor 514.

Optionally, the Macro lens may have a fixed effective focal length (EFL) providing a fixed zoom factor (ZF), or an adaptable (variable) EFL providing an adaptable ZF. The adaption of EFL may be discrete or continuous, i.e. a discrete number of varying EFLs for providing a plurality of discrete or continuous zoom states with respective ZFs. Camera 510 may be switched to a beneficial zoom state automatically.

Optionally, Macro camera 510 may be a folded camera that includes an OPFE 518 and an OPFE actuator 522 for actuating OPFE 518 for OIS and/or FOV scanning. In some embodiments, the FOV scanning of the Macro camera may be performed by actuating one or more OPFEs. A scanning Macro camera that performs FOV scanning by actuating two OPFEs is described for example in the co-owned U.S. provisional patent application No. 63/110,057 filed Nov. 5, 2020.

Macro camera module 510 further comprises a first memory 524, e.g. in an EEPROM (electrically erasable programmable read only memory). In some embodiments, first calibration data may be stored in memory 524. In other embodiments, the first calibration data may be stored in a third memory 560 such as a NVM (non-volatile memory). The first calibration data may comprise calibration data between image sensors 514 and 534.

Electronic device 500 further comprises a UW camera 530 with a FOV_{UW} larger than FOV_{M} of camera 510. UW camera 530 includes UW lens module 532 with a UW lens and a UW image sensor 534. A lens actuator 536 may move lens module 532 for focusing and/or OIS. In some embodiments, second calibration data may be stored in a second memory 538. In other embodiments, the second calibration data may be stored in third memory 560. The second calibration data may comprise calibration data between image sensors 514 and 534.

The Macro camera may have an effective focal length (EFL) of e.g. 8-30 mm or more, a diagonal FOV of 10-40 deg and a f number of about f/#=1.8-6. The UW camera may have an EFL of e.g. 2.5-8 mm, a diagonal FOV of 50-130 deg and a f/# of about 1.0-2.5.

In some embodiments, the Macro camera may cover about 50% of the area of the UW camera's FOV. In some embodiments, the Macro camera may cover about 10% or less of the area of the UW camera's FOV.

Electronic device 500 further comprises an application processor (AP) 540. Application processor 540 comprises a camera controller 542, a user control unit 544, OOI/ROI selector 546 and an image processor 548. Electronic device 500 further comprises a screen control 550 and a screen 570. Screen 570 may display methods as disclosed herein.

Returning now to the method of use as in FIG. 4, in some examples, the UW or W camera image data may be used by camera controller 542 to automatically change a state of the Macro camera (i.e. control a change of scan state of the Macro camera). The state may be a scan (or steer) state, a zoom state or a focus state. For example, UW or W camera image data may be used to steer (or scan) the FOV_{M} of a scanning Tele camera automatically towards a ROI (change of scan state of the Macro camera). In an example, the Macro camera can steer itself, and step 406 of guiding FOV_{M} to the ROI can be done automatically by camera control 542. As indicated above, the selection of an OOI/ROI in the FOV_{UW} as a scene for the Macro image camera may be done by a dedicated algorithm running on OOI/ROI selector 546. In another example, the Macro camera may use UW or W image data to switch between zoom states. Camera controller 542 may switch the Macro camera to a beneficial zoom state automatically (i.e. control a change of zoom state of the Macro camera), e.g. while executing steps 404 and 406. A beneficial zoom state may be a state where a Macro OOI or ROI fully enters FOV_{M}. In yet another example, the W or UW camera's image data may be used by camera controller 542 to focus the Macro camera to a ROI within FOV_{M} automatically (i.e. control a change of focus state of the Macro camera). An OOI or ROI spanning a segment of a scene which is larger than FOV_{M} may be fully captured in two or more sequential frames wherein each frame includes a different segment of the OOI or ROI. The sequential frames together include image data on the OOI or ROI in its entirety and are stitched to a single image by image processor 548.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present disclosure.

What is claimed is:

1. A mobile electronic device, comprising:
a first camera with a first field of view FOV₁ and a first focal length between 2 mm and 8 mm;
a second, Macro camera with a Macro field of view FOV_{M} smaller than FOV₁; and
a device screen that includes a first screen section configured to display first image data from the first camera and a second screen section configured to display second image data from the Macro camera when both cameras are focused to a distance equal to or smaller than 30 cm.

2. The mobile electronic device of claim 1, wherein the FOV_{M} is shown and marked within the first screen section.

3. The mobile electronic device of claim 1, wherein the first screen section includes a visual indication for guiding a user of the mobile electronic device towards a scene using the FOV_{M}.

4. The mobile electronic device of claim 1, wherein the second screen section displays first image data from the first camera.

5. The mobile electronic device of claim 1, further comprising a controller for controlling a change in state of the Macro camera based on the first image data.

6. The mobile electronic device of claim 1, wherein the first screen section and the second screen section are split vertically when the mobile electronic device is held in a landscape orientation, and wherein the first screen section and the second screen section are split horizontally when the mobile electronic device is held in a portrait orientation.

7. The mobile electronic device of claim 1, wherein the Macro camera has a second focal length, and wherein the second focal length is 5 times to 25 times larger than the first focal length.

8. The mobile electronic device of claim 1, wherein the Macro camera has a second focal length between 12 mm and 40 mm.

9. The mobile electronic device of claim 1, wherein the Macro camera has a second focal length between 15 mm and 20 mm.

10. The mobile electronic device of claim 1, wherein the Macro camera has a second focal length between 15 mm and 30 mm.

11. The mobile electronic device of claim 1, wherein the Macro camera has a second focal length between 20 mm and 30 mm.

12. The mobile electronic device of claim 1, wherein the first focal length is between 2 mm and 10 mm.

13. The mobile electronic device of claim 1, wherein the first focal length is between 2 mm and 7 mm.

14. The mobile electronic device of claim 1, wherein both cameras can be focused to a distance smaller than 20 cm.

15. The mobile electronic device of claim 1, wherein both cameras can be focused to a distance of 10 cm or less.

16. The mobile electronic device of claim 1, wherein at least one camera can be focused to a distance between 5 and 10 cm.

17. The mobile electronic device of claim 1, wherein at least one camera can be focused to a distance of 5 cm or less.

18. The mobile electronic device of claim 1, wherein the first camera is a Wide camera.

19. The mobile electronic device of claim 1, wherein the first camera is focused to a first distance different from a second distance that the Macro camera is focused to.

20. The mobile electronic device of claim 1, wherein the mobile electronic device is a smartphone.
